(19) United States
(12) Patent Application Publication
(10) Pub. No.: US 2021/0039764 A1
(43) Pub. Date: Feb. 11, 2021

(54) UNMANNED AERIAL VEHICLES AND FRAMES THEREOF

(71) Applicant: SZ DJI TECHNOLOGY CO., LTD., Shenzhen (CN)

(72) Inventors: Xiaolong WU, Shenzhen (CN); Lei DENG, Shenzhen (CN); Chuoying LU, Shenzhen (CN)

(73) Assignee: SZ DJI TECHNOLOGY CO., LTD., Shenzhen (CN)

(21) Appl. No.: 17/081,944

(22) Filed: Oct. 27, 2020

Related U.S. Application Data
(63) Continuation of application No. PCT/CN2018/085095, filed on Apr. 28, 2018.

(51) Int. Cl. B64C 1/06; B64C 39/02

(52) U.S. Cl. CPC B64C 1/063; B64C 39/024; B64C 2201/20; B64C 2201/027; B64C 2201/108; B64C 2201/024

(57) ABSTRACT

Unmanned aerial vehicles and frames thereof are disclosed. The unmanned aerial vehicle includes a frame and a control module. The frame includes a central frame, a first arm set, and a second arm set. Each of the first arm set and the second arm set includes a second arm assembly, a third arm assembly, and a first arm assembly. The first arm assembly is located between the second arm assembly and the third arm assembly. The first arm assembly includes a first rotor assembly. The second arm assembly includes a second rotor assembly. The third arm assembly includes a third rotor assembly. In an output direction of downward-propelling wind fields, one of a rotation plane of the first rotor assembly, a rotation plane of the second rotor assembly, and a rotation plane of the third rotor assembly is located at a different position from the other two.

### RELATED APPLICATIONS

The present patent document is a continuation of PCT Application Serial No. PCT/CN2018/085095, filed on Apr. 28, 2018, designating the United States and published in Chinese, which is hereby incorporated by reference.

### BACKGROUND

### 1. Technical Field

The present disclosure relates to the technical field of unmanned aerial vehicles, and more particularly, to an unmanned aerial vehicle and a frame thereof.

### 2. Background Information

An unmanned aerial vehicle may include a frame and several rotor assemblies that radially extend outward from the frame. Examples thereof are multi-rotor unmanned aerial vehicles with four rotors, six rotors, or eight rotors. A rotor assembly may include a connecting rod fixed on the frame, a motor mounted on the connecting rod, and a rotor mounted on an output shaft of the motor. The motor drives the rotor to rotate, so that the unmanned aerial vehicle performs a flying action. In the related art, the rotor assemblies extend outward from the frame and are located in the same plane.

When the rotor assemblies are in a flying state, a rotor of each rotor assembly performs rotation operations. Swept ranges of rotors of adjacent rotor assemblies are mutually staggered to avoid mutual impact. Correspondingly, a downward-propelling wind field generated by the rotation of each rotor is also in an independent state, and the downward-propelling wind field depends on wind pressure generated by the rotation of the rotor itself.

The unmanned aerial vehicle may be applied to the agricultural field, and used for spraying operations. Agricultural unmanned aerial vehicles include multi-rotor unmanned aerial vehicles such as a six-rotor unmanned aerial vehicle and an eight-rotor unmanned aerial vehicle. An agricultural unmanned aerial vehicle needs to carry liquid to perform spraying operations. Correspondingly, a rotor assembly may be provided with a nozzle for spraying the liquid. Through a downward-propelling wind field generated by the rotation of a rotor, the liquid is sprayed to crops in a flying path of the unmanned aerial vehicle. A strong wind in the downward-propelling wind field can improve penetration of the liquid, so that the liquid is sprayed in plant spacings of the crops. However, because the downward-propelling wind field generated by each rotor is mutually independent, and there is mutual interference between lower areas of the downward-propelling wind fields, the downward-propelling wind fields generated during the flying of the unmanned aerial vehicle are in disorder. Correspondingly, the sprayed liquid also becomes disordered in the presence of the downward-propelling wind fields, resulting in poor penetration of the liquid and a poor spraying effect.

### BRIEF SUMMARY

According to a first aspect of the embodiments of the present disclosure, a frame of an unmanned aerial vehicle is provided. The frame may include a central frame, and a left arm set and a right arm set that may be symmetrically mounted on two sides of the central frame, wherein each of the left arm set and the right arm set may include a front arm assembly, a rear arm assembly, and a middle arm assembly that are assembled on the central frame, the middle arm assembly may be located between the front arm assembly and the rear arm assembly, the middle arm assembly may include a first rotor assembly, the front arm assembly may include a second rotor assembly, the rear arm assembly includes a third rotor assembly, and in an output direction of downward-propelling wind fields of the left arm set and the right arm set, a rotation plane of at least one of the first rotor assembly, the second rotor assembly, and the third rotor assembly may be at a different vertical position.

In some embodiments, the first rotor assembly may be located at an end of the middle arm assembly, the second rotor assembly may be located at an end of the front arm assembly, the third rotor assembly may be located at an end of the rear arm assembly, a vertical position of the end of the middle arm assembly is lower than a vertical position of the end of the front arm assembly, and the vertical position of the end of the middle arm assembly may be lower than a vertical position of the end of the rear arm assembly.

In some embodiments, the middle arm assembly may include a first connecting rod set for connecting the first rotor assembly to the central frame, the front arm assembly may include a second connecting rod set for connecting the second rotor assembly to the central frame, the rear arm assembly may include a third connecting rod set for connecting the third rotor assembly to the central frame, a vertical position of the first connecting rod set may be lower than a vertical position of the second connecting rod set, and the vertical position of the first connecting rod set may be lower than a vertical position of the third connecting rod set.

In some embodiments, a distance between the first connecting rod set and the third connecting rod set may be greater than a distance between the first connecting rod set and the second connecting rod set.

In some embodiments, a total length of the middle arm assembly may be greater than a total length of the front arm assembly, and the total length of the middle arm assembly may be greater than a total length of the rear arm assembly.

In some embodiments, the total length of the front arm assembly may be equal to the total length of the rear arm assembly.

In some embodiments, the first rotor assembly may include a first propeller, the second rotor assembly may include a second propeller, and the third rotor assembly may include a third propeller, wherein in the output direction of the downward-propelling wind fields of the left arm set and the right arm set, a swept range of the first propeller may partially overlap a swept range of the second propeller, and/or a swept range of the first propeller may partially overlap a swept range of the third propeller.

In some embodiments, the front arm assembly, the rear arm assembly, and the middle arm assembly are all rotatably and/or pivotably coupled to the central frame; and the front arm assembly, the rear arm assembly, and the middle arm assembly may all be pivotable to folded positions close to the central frame to get in, or can radially extend outward from the central frame to be in flying positions.

In some embodiments, rotation directions of the front arm assembly, the rear arm assembly, and the middle arm assembly may be the same; or the front arm assembly and the middle arm assembly may pivot toward the rear arm assembly, and the rear arm assembly pivots toward the middle arm assembly.

In some embodiments, the frame may further comprise a locking apparatus fixed on the central frame, wherein the front arm assembly, the rear arm assembly, and the middle arm assembly may all be fixedly or rotatably and/or pivotably coupled to the central frame by such locking apparatuses.

In some embodiments, the locking apparatus may include a fixing base and a locking member that are fixedly connected to the central frame; the front arm assembly, the rear arm assembly, and the middle arm assembly may be respectively rotatably and/or pivotably coupled to the corresponding fixing bases; and each of the front arm assembly, the rear arm assembly, and the middle arm assembly may be sleeved over by a locking member, wherein the locking member may be locked to the fixing base and prevents the front arm assembly, the rear arm assembly, or the middle arm assembly from rotating around the corresponding fixing base.

In some embodiments, the fixing base may comprise a fixing portion fixedly connected to the central frame and a connecting portion protruding from the fixing portion; the front arm assembly, the rear arm assembly, or the middle arm assembly may be rotatably and/or pivotably coupled to the connecting portion; and the locking member may be fixed to the connecting portion and externally sleeve over the front arm assembly, the rear arm assembly, or the middle arm assembly.

In some embodiments, the frame may further comprise a linkage assembly assembled on the central frame, wherein the linkage assembly may be configured to drive the front arm assembly, the rear arm assembly, and the middle arm assembly to synchronously or sequentially pivot.

According to a second aspect of the embodiments of the present disclosure, an unmanned aerial vehicle is provided. The unmanned aerial vehicle may include a frame including a central frame, and a first arm set and a second arm set, and the first arm set and the second arm set may be mounted on the central frame, each of the first arm set and the second arm set may include a first arm assembly, a second arm assembly, and a third arm assembly, and the first arm assembly, the second arm assembly, and the third arm assembly may be assembled on the central frame, the first arm assembly may be located between the second arm assembly and the third arm assembly, and a control module mounted on the frame and configured to control the first arm set and the second arm set, wherein the first arm assembly may include a first rotor assembly, the second arm assembly may include a second rotor assembly, the third arm assembly may include a third rotor assembly, in an output direction of downward-propelling wind fields generated by the first arm set and the right arm set, one of a rotation plane of the first rotor assembly, a rotation plane of the second rotor assembly, and a rotation plane of the third rotor assembly is located at different position from the other.

In some embodiments, the first rotor assembly may be located at an end of the first arm assembly, the second rotor assembly may be located at an end of the second arm assembly, the third rotor assembly may be located at an end of the third arm assembly, a vertical position of the end of the first arm assembly may be lower than a vertical position of the end of the second arm assembly, and the vertical position of the end of the first arm assembly may be lower than a vertical position of the end of the third arm assembly.

In some embodiments, the first arm assembly may include a first connecting rod set for connecting the first rotor assembly to the central frame, the second arm assembly may include a second connecting rod set for connecting the second rotor assembly to the central frame, the third arm assembly may include a third connecting rod set for connecting the third rotor assembly to the central frame, a vertical position of the first connecting rod set may be lower than a vertical position of the second connecting rod set, and the vertical position of the first connecting rod set may be lower than a vertical position of the third connecting rod set.

In some embodiments, a distance between a first position where the first connecting rod set may be connected to the central frame and a third position where the third connecting rod set is connected to the central frame may be greater than a distance between the first position and a second position where the second connecting rod set is connected to the central frame.

In some embodiments, a total length of the first arm assembly may be greater than a total length of the second arm assembly, and the total length of the first arm assembly may be greater than a total length of the third arm assembly.

In some embodiments, the total length of the second arm assembly may be equal to the total length of the third arm assembly.

In some embodiments, the first rotor assembly may include a first propeller, the second rotor assembly may include a second propeller, the third rotor assembly may include a third propeller, and in the output direction of the downward-propelling wind fields generated by the first arm set and the second arm set, a swept range of the first propeller may at least partially overlap at least one of a swept range of the second propeller or a swept range of the third propeller.

In some embodiments, the first arm assembly, the second arm assembly, and the third arm assembly may all be rotatably and/or pivotably coupled to the central frame; and each of the second arm assembly, the third arm assembly, and the first arm assembly may be configured to rotate or pivot to a folded position adjacent to the central frame, or may be configured to radially extend outward from the central frame to be at a deployed position.

In some embodiments, rotation and/or pivoting directions of the second arm assembly, the third arm assembly, and the first arm assembly from the folded position to the deployed position may be the same; or when moving from the respective deployed position to the folded position, the second arm assembly and the first arm assembly rotate and/or pivot toward the third arm assembly, respectively, and the third arm assembly may rotate and/or pivot toward the first arm assembly.

In some embodiments, the unmanned aerial vehicle may further comprise a plurality of locking apparatuses fixed on the central frame, wherein the first arm assembly, the second arm assembly, and the third arm assembly may all be fixedly or rotatably and/or pivotably coupled to the central frame by the corresponding locking apparatus.

In some embodiments, the locking apparatus may include a fixing base and a locking member, the fixing base is fixedly connected to the central frame, each of the second arm assembly, the third arm assembly, and the first arm assembly may be rotatably and/or pivotably coupled to a corresponding fixing base, the locking member is configured to prevent the first arm assembly, the second arm assembly, or the third arm assembly from rotating around the corresponding fixing base.

In some embodiments, each of the first arm assembly, the second arm assembly, and the third arm assembly is sleeved over by the corresponding locking member.

In some embodiments, the fixing base may include a fixing portion fixedly connected to the central frame and a connecting portion protruding from the fixing portion, at least one of the second arm assembly, the third arm assembly, or the first arm assembly may be rotatably and/or pivotably coupled to the connecting portion.

In some embodiments, the locking member may be fixed to the connecting portion and externally sleeve over the second arm assembly, the third arm assembly, or the first arm assembly.

In some embodiments, an external surface of the connecting portion may be provided with a first external partial-thread, at least one of the first arm assembly, the second arm assembly, or the third arm assembly may have a threaded portion having a corresponding second external partial-thread to complement the first external partial-thread.

In some embodiments, the first external partial-thread may extend partially over the peripheral of the connecting portion, the second external partial-thread may extend partially over the peripheral of at least one of the first arm assembly, the second arm assembly, and the third arm assembly, the first external partial-thread and second external partial-thread may complete full circles of threads.

In some embodiments, the connecting portion may be provided with an opening to accommodate the at least one of the first arm assembly, the second arm assembly, or the third arm assembly.

In some embodiments, the locking member may be provided with an internal thread to fit with the first external partial-thread and the second external partial-thread, the locking member may be movable between a locking position and an unlocking position along an axial direction of the at least one of the first arm assembly, the second arm assembly, or the third arm assembly, in the locking position, the locking member may be coupled to the connecting portion via the internal threads fitting with the first external partial-thread and the second external partial-thread, to lock the at least one of the first arm assembly, the second arm assembly, or the third arm assembly, and in the unlocking position, the locking member may be detached from the connecting portion, to unlock the at least one of the first arm assembly, the second arm assembly, or the third arm assembly.

In some embodiments, the unmanned aerial vehicle may further comprise a linkage assembly assembled on the central frame, wherein the linkage assembly may be configured to drive the second arm assembly, the third arm assembly, and the first arm assembly to pivot synchronously or sequentially.

According to a third aspect of the embodiments of the present disclosure, an unmanned aerial vehicle is provided. The unmanned aerial vehicle may comprise: a central frame; a first arm assembly rotatably coupled to the central frame and including a first rotor assembly; a second arm assembly rotatably coupled to the central frame and including a second rotor assembly; a third arm assembly rotatably coupled to the central frame, the first arm assembly being located between the second arm assembly and the third arm assembly; and a control module mounted on the central frame and configured to control the first rotor assembly, the second rotor assembly and the third arm assembly, wherein: each of the first arm assembly, the second arm assembly, and the third arm assembly is configured to rotate to a folded position adjacent to the central frame, and radially extend outward from the central frame to be at a deployed position; and when all of the first arm assembly, the second arm assembly, and the third arm assembly being at the deployed position, a rotation plane of the first rotor assembly is located at a different height from a rotation plane of the second rotor assembly or the third rotor assembly.

The technical solutions provided by the embodiments of the present disclosure may include the following beneficial effects. The symmetrical design of the left arm set and the right arm set on two sides of a center frame may balance the forces applied on the unmanned aerial vehicle during flying. At least one of the first rotor assembly, the second rotor assembly, and the third rotor assembly may be located at a different vertical position to generate downward-propelling wind fields that have overlapping coverage, thereby improving the wind strength in the downward-propelling wind fields and the penetration of the liquid in the downward-propelling wind fields.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely exemplary embodiments of the present disclosure, and a person of ordinary skill in the art may still derive other drawings from these accompanying drawings without creative efforts.

FIG. 1 is a top schematic view illustrating a structure of an unmanned aerial vehicle according to exemplary embodiments of the present disclosure;

FIG. 2 is a schematic view illustrating a structure in which a frame of an unmanned aerial vehicle is in a folded position according to exemplary embodiments of the present disclosure;

FIG. 3 is a side schematic view illustrating a structure of a frame of an unmanned aerial vehicle according to exemplary embodiments of the present disclosure;

FIG. 4 is a schematic view illustrating a structure in which a right arm set in a frame of an unmanned aerial vehicle is in a deployed position according to exemplary embodiments of the present disclosure; and

FIG. 5 is an exploded schematic view illustrating a structure of a frame of an unmanned aerial vehicle according to exemplary embodiments of the present disclosure.

Elements in the drawings: central frame 10; fuselage assembly 101; left arm set 20; right arm set 30; front arm assembly 21; middle arm assembly 22; rear arm assembly 23; first rotor assembly 221; first connecting rod set 222; second rotor assembly 211; second connecting rod set 212; third rotor assembly 231; third connecting rod set 232; threaded portion 233; locking apparatus 40; base 41; fixed portion 411; connecting portion 412; first external partial-thread 413; opening 414; and locking member 42.

### DETAILED DESCRIPTION OF THE DRAWINGS

The following clearly and completely describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts shall fall within the protection scope of the present disclosure.

The following description provides specific application scenarios and requirements of the present application in order to enable those skilled in the art to make and use the present application. Various modifications to the disclosed embodiments will be apparent to those skilled in the art. The general principles defined herein may be applied to other embodiments and applications without departing from the spirit and scope of the disclosure. Therefore, the present disclosure is not limited to the embodiments shown, but the broadest scope consistent with the claims.

The terminology used herein is for the purpose of describing particular exemplary embodiments only and is not intended to be limiting. When used in this disclosure, the terms “comprises”, “comprising”, “includes” and/or “including” refer to the presence of stated features, integers, steps, operations, elements, and/or components, but do not preclude the presence or addition of one or more other features, integers, steps, operations, elements, components, and/or groups thereof. As used in this disclosure, the term “A on B” means that A is directly adjacent to B (from above or below), and may also mean that A is indirectly adjacent to B (i.e., there is some element between A and B); the term “A in B” means that A is all in B, or it may also mean that A is partially in B. As used in this disclosure, the spatial term “above”, “below”, “left”, “right”, “front”, and “rear” may have different meaning if viewed from a different direction and may be mutually exchangeable. For example, the term “A above B” may mean that A is located above B if viewed from a direction, or it may mean A is located below B if viewed from an opposite direction.

In view of the following description, these and other features of the present disclosure, as well as operations and functions of related elements of the structure, and the economic efficiency of the combination and manufacture of the components, may be significantly improved. All of these form part of the present disclosure with reference to the drawings. However, it should be clearly understood that the drawings are only for the purpose of illustration and description, and are not intended to limit the scope of the present disclosure. It is also understood that the drawings are not drawn to scale.

In exemplary embodiments, numbers expressing quantities or properties used to describe or define the embodiments of the present application should be understood as being modified by the terms “about”, “generally”, “approximate,” or “substantially” in some instances. For example, “about”, “generally”, “approximately” or “substantially” may mean a ±20% change in the described value unless otherwise stated. Accordingly, in exemplary embodiments, the numerical parameters set forth in the written description and the appended claims are approximations, which may vary depending upon the desired properties sought to be obtained in a particular embodiment. In exemplary embodiments, numerical parameters should be interpreted in accordance with the value of the parameters and by applying ordinary rounding techniques. Although a number of embodiments of the present application provide a broad range of numerical ranges and parameters that are approximations, the values in the specific examples are as accurate as possible.

Each of the patents, patent applications, patent application publications, and other materials, such as articles, books, instructions, publications, documents, products, etc., cited herein are hereby incorporated by reference, which are applicable to all contents used for all purposes, except for any history of prosecution documents associated therewith, or any identical prosecution document history, which may be inconsistent or conflicting with this document, or any such subject matter that may have a restrictive effect on the broadest scope of the claims associated with this document now or later. For example, if there is any inconsistent or conflicting in descriptions, definitions, and/or use of a term associated with this document and descriptions, definitions, and/or use of the term associated with any materials, the term in this document shall prevail.

It should be understood that the embodiments of the application disclosed herein are merely described to illustrate the principles of the embodiments of the application. Other modified embodiments are also within the scope of this application. Therefore, the embodiments disclosed herein are by way of example only and not limitations. Those skilled in the art may adopt alternative configurations to implement the subject matters in this application in accordance with the embodiments of the present application. Therefore, the embodiments of the present application are not limited to those embodiments that have been precisely described in this disclosure.

The terms used in this application are used only for describing specific embodiments, and not intended to limit this application. The terms “a”, “said” and “the” of singular forms used in this application and the appended claims are also intended to include plural forms, unless otherwise clearly specified in the context. It should also be understood that, the term “and/or” used in this specification indicates and includes any or all possible combinations of one or more associated listed items. Unless otherwise specified, terms similar to “a front portion”, “a middle portion”, “a rear portion”, “a lower portion”, and/or “an upper portion”, or the like are used only for ease of description, and not intended to limit a location or a spatial direction. For example, the term “downward” may also refer to leftward, rightward, upward, forward, backward or other directions. Terms similar to “connect”, “connected”, or the like are not limited to a physical or mechanical connection, but may include an electrical connection, whether directly or indirectly.

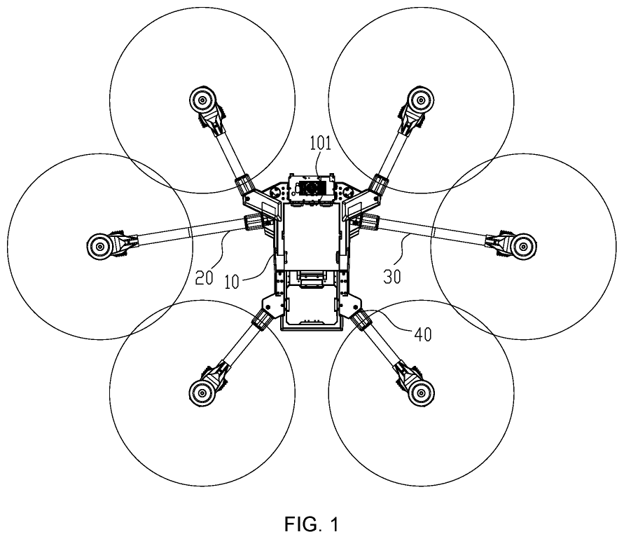

As shown in FIG. 1, an unmanned aerial vehicle may include a frame, a control module mounted on the frame, and a fuselage assembly 101 mounted on the frame. The frame may include a central frame 10, and a left arm set 20 and a right arm set 30. The left arm set 20 and a right arm set 30 may be mounted and symmetrically distributed on two sides of the central frame 10. The control module may be mounted on the central frame 10, and electrically connected to the left arm set 20 and the right arm set 30. The control module may be configured to control the movement of the left arm set 20 and the right arm set 30. For example, the control module may control the left arm set 20 and the right arm set 30 to execute corresponding control instructions, so that the unmanned aerial vehicle performs actions such as flying along a straight line, turning around, ascending, descending, etc.

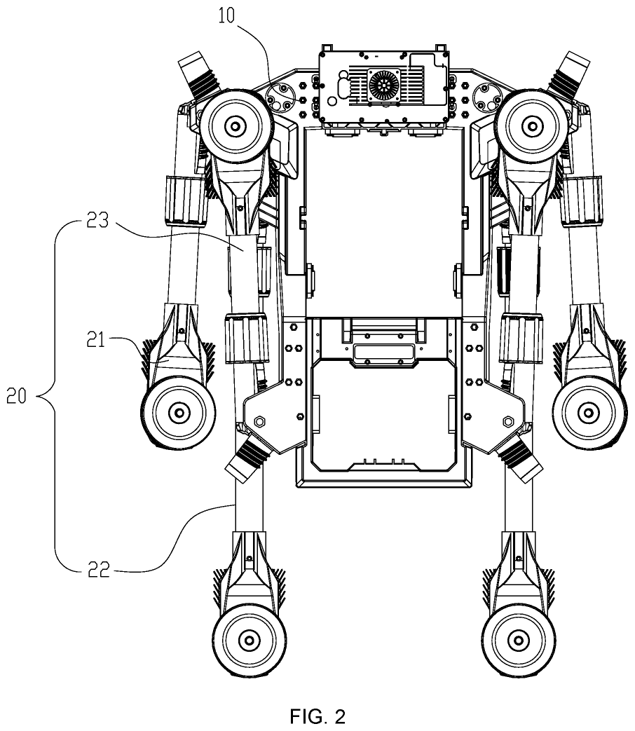

As shown in FIG. 2, the left arm set 20 and the right arm set 30 may be symmetrically distributed to keep the unmanned aerial vehicle balanced during the flying. Each of the left arm set 20 and the right arm set 30 may include a front arm assembly 21, a rear arm assembly 23, and a middle arm assembly 22. The front arm assembly 21, the rear arm assembly 23, and the middle arm assembly 22 may be assembled on the central frame 10. The middle arm assembly 22 may be located between the front arm assembly 21 and the rear arm assembly 23. The middle arm assembly 22 may include a first rotor assembly 221. The front arm assembly 21 may include a second rotor assembly 211. The rear arm assembly 23 may include a third rotor assembly 231. The front arm assembly 21, the rear arm assembly 23, and the middle arm assembly 22 may radially extend outward from the central frame 10. Under the control of the control module, the first rotor assembly 221, the second rotor assembly 211, and the third rotor assembly 231 may perform corresponding rotation actions, for example, to rotate at the same rotation speed. In some embodiments, the rotation speeds of one or more of the first rotor assembly 221, the second rotor assembly 211, and the third rotor assembly 231 may be different from another.

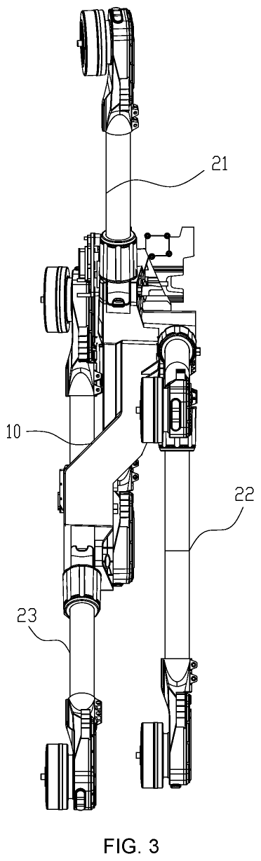

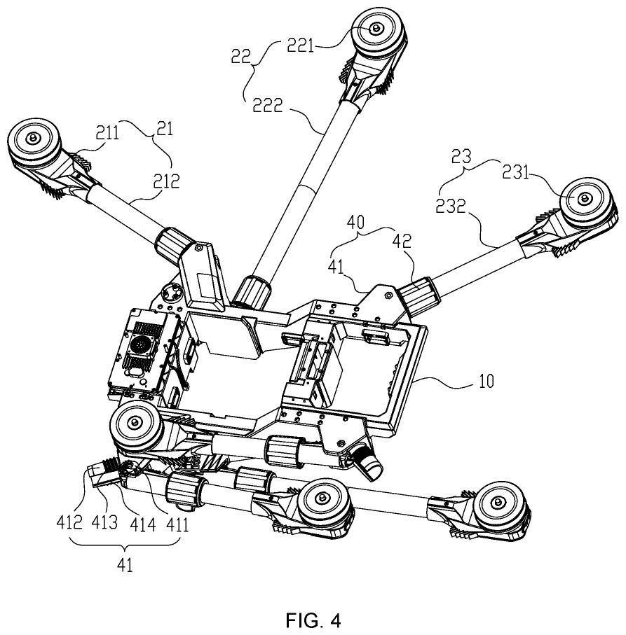

As shown in FIG. 3 and FIG. 4, in an output direction of downward-propelling wind fields of the left arm set 20 and the right arm set 30, a rotation plane of at least one of the first rotor assembly 221, the second rotor assembly 211, and the third rotor assembly 231 may be at different vertical positions. The first rotor assembly 221, the second rotor assembly 211, and the third rotor assembly 231 may rotate to drive the unmanned aerial vehicle to fly and generate downward-propelling wind fields under the first rotor assembly 221, the second rotor assembly 211, and the third rotor assembly 231. The rotation plane of at least one of the first rotor assembly 221, the second rotor assembly 211, and the third rotor assembly 231 may be different from another, and this may affect the distribution of the downward-propelling wind fields.

In some embodiments, the rotation plane of the first rotor assembly 221 may be lower than the rotation planes of the second rotor assembly 211 and the third rotor assembly 231, and the downward-propelling wind fields generated by the second rotor assembly 211 and the third rotor assembly 231 may partially overlap the downward-propelling wind field generated by the first rotor assembly 221, so that the penetration of the downward-propelling wind field of the first rotor assembly 221 may be improved.

In some embodiments, the unmanned aerial vehicle may be applied to the agricultural field, and configured to spray liquid such as pesticide. The agricultural unmanned aerial vehicle may further include a spraying system. The spraying system may be mounted on the frame. The spraying system may include a water tank and a nozzle assembly. The water tank of the spraying system may be fixedly connected to the frame. The nozzle assembly may be mounted on each of the left arm set 20 and the right arm set 30. In some embodiments, the nozzle assembly may be mounted on the middle arm assembly 22 of each of the left arm set 20 and the right arm set 30. The liquid sprayed by the nozzle assembly may be within the ranges of the downward-propelling wind fields generated by the rotation of the first rotor assembly 221, the second rotor assembly 211, and the third rotor assembly 231. The unmanned aerial vehicle may fly and drive the spraying system to perform spraying operations along the path of flying, and the liquid may be dispersed by and penetrate through the downward-propelling wind fields towards crops that are passed by. Because the downward-propelling wind fields are mutually overlapped, the downward-propelling wind pressure of the downward-propelling wind fields may be increased, and the penetration of the liquid may be stronger.

In some embodiments, the first rotor assembly 221 may be located at an end of the middle arm assembly 22, the second rotor assembly 211 may be located at an end of the front arm assembly 21, and the third rotor assembly 231 may be located at an end of the rear arm assembly 23. The first rotor assembly 221, the second rotor assembly 211, and the third rotor assembly 231 may be located in the outermost areas of the unmanned aerial vehicle, respectively, where the ranges of their downward-propelling wind fields are wide. A vertical position of the end of the middle arm assembly 22 may be lower than a vertical position of the end of the front arm assembly 21, and the vertical position of the end of the middle arm assembly 22 may be lower than a vertical position of the end of the rear arm assembly 23. The end of the middle arm assembly 22 may be located below the front arm assembly 21 and the rear arm assembly 23. Correspondingly, a vertical position of a rotation plane of the first rotor assembly 221 may be lower than a vertical position of a rotation plane of the second rotor assembly 211, and may also be lower than a vertical position of a rotation plane of the third rotor assembly 231. In some embodiments, in the directions of the downward-propelling wind fields, a swept range of the first rotor assembly 221 may at least partially overlap a swept range of the second rotor assembly 211. In some embodiments, in the output direction of the downward-propelling wind fields, a swept range of the third rotor assembly 231 may at least partially overlap the swept range of the first rotor assembly 221. Therefore, when the unmanned aerial vehicle is in a flying state, the downward-propelling wind fields generated by the second rotor assembly 211 and the third rotor assembly 231 may act on the downward-propelling wind field generated by the first rotor assembly 221. Therefore, the downward-propelling wind generated by the first rotor assembly 221 may be stronger, the energy provided by the downward-propelling wind to the liquid may be increased, and the penetration of the liquid may be improved.

The rotation plane of the first rotor assembly 221 may be located on a plane different from the rotation planes of the second rotor assembly 211 and the third rotor assembly 231. In some embodiments, the rotation planes of the second rotor assembly 211 and the third rotor assembly 231 may be located in the same plane. The first rotor assembly 221 may be located in a middle position on the central frame 10. The second rotor assembly 211 and the third rotor assembly 231 may be located on two sides of the first rotor assembly 221. The downward-propelling wind fields generated by the second rotor assembly 211 and the third rotor assembly 231 may act on two sides of the downward-propelling wind field generated by the first rotor assembly 221 and may at least partially overlap the downward-propelling wind field generated by the first rotor assembly 221, so that the downward-propelling wind field generated by the first rotor assembly 221 is strengthened. When the nozzle assembly is mounted on the middle arm assembly 22, the liquid ejected by the nozzle assembly may be sprayed on crops under the action of the strengthened downward-propelling wind field, and may have a better penetration effect.

The middle arm assembly 22 may include a first connecting rod set 222 for connecting the first rotor assembly 221 to the central frame 10. The first connecting rod set 222 may be configured to support the first rotor assembly 221, and keep the first rotor assembly 221 at a stable position with respect to the central frame 10. The front arm assembly 21 may include a second connecting rod set 212 for connecting the second rotor assembly 211 to the central frame 10. The rear arm assembly 23 may include a third connecting rod set 232 for connecting the third rotor assembly 231 to the central frame 10. Correspondingly, the functions of the second connecting rod set 212 and the third connecting rod set 232 may be the same as the function of the first connecting rod set 222. A vertical position of the first connecting rod set 222 may be lower than a vertical position of the second connecting rod set 212, and the vertical position of the first connecting rod set 222 may be lower than a vertical position of the third connecting rod set 232.

The structures of the first connecting rod set 222, the second connecting rod set 212, and the third connecting rod set 232 may be configured to have straight or curved shapes. The position of the rotation plane of the first rotor assembly 221 may be adjusted correspondingly based on a position where the first connecting rod set 222 and the central frame 10 is connected and the shape of the first connecting rod set 222. In some embodiments, if the shapes of the first connecting rod set 222, the second connecting rod set 212, and the third connecting rod set 232 are all straight, the rotation plane of the first rotor assembly 221 with respect to the second rotor assembly 211 and the third rotor assembly 231 may be determined by a vertical position at which the first connecting rod set 222 is mounted on the central frame 10. In some embodiments, when observing from a side of a flying unmanned aerial vehicle, connecting portions 412 for respectively connecting each of the first connecting rod set 222, the second connecting rod set 212, and the third connecting rod set 232 to the central frame 10 may form vertexes of a triangle, where the first connecting rod set 222 is at the lowest position.

The positions of the connecting portion 412 for respectively connecting the first connecting rod set 222, the second connecting rod set 212, and the third connecting rod set 232 to the central frame 10 may be adjusted to adjust the relative positions of the first rotor assembly 221, the second rotor assembly 211, and the third rotor assembly 231, so as to adjust the ranges of the downward-propelling wind fields of the unmanned aerial vehicle, such that the distribution of the downward-propelling wind fields may be adjusted conveniently. Because the first connecting rod set 222 is in the lowest position, when the agricultural unmanned aerial vehicle sprays the liquid, the capability of the flying unmanned aerial vehicle to keep balance against a counterforce of the liquid may be improved.

As shown in FIG. 1 and FIG. 4, in some embodiments, a distance between the first connecting rod set 222 and the third connecting rod set 232 may be greater than a distance between the first connecting rod set 222 and the second connecting rod set 212. The first connecting rod set 222 may be close to the second connecting rod set 212. The connecting portion 412 for connecting the second connecting rod set 212 to the central frame 10 may be close to an end of the unmanned aerial vehicle that is close to the head thereof. The first connecting rod set 222 may be connected to the central frame 10 and tilt to a side of the third connecting rod set 232. The first rotor assembly 221 may be located in a middle area between the second rotor assembly 211 and the third rotor assembly 231, so that at least edges of the swept ranges of the second rotor assembly 211 and the third rotor assembly 231 may partially overlap an edge of the swept range of the first rotor assembly 221. When observing from the top of a flying unmanned aerial vehicle, a circular range generated by the rotation of the first rotor assembly 221 may overlap circular ranges generated by the rotation of the second rotor assembly 211 and the third rotor assembly 231.

The connecting portion 412 between the central frame 10 and each of the first connecting rod set 222, the second connecting rod set 212, and the third connecting rod set 232 may be adjusted to balance the vibration force applied by the first rotor assembly 221, the second rotor assembly 211, and the third rotor assembly 231 to the central frame 10.

In some embodiments, a total length of the middle arm assembly 22 is greater than a total length of the front arm assembly 21, and the total length of the middle arm assembly 22 is greater than a total length of the rear arm assembly 23. The total length of the middle arm assembly 22 includes a sum of length directions of the first connecting rod set 222 and the first rotor assembly 221, and a length direction thereof is a direction extending from an intersecting portion of the central frame 10 to the first rotor assembly 221. When the unmanned aerial vehicle is applied to the agricultural field, the nozzle assembly is mounted on the first connecting rod set 222. When the length of the first connecting rod set 222 is increased, a range for mounting the nozzle assembly is large, and a nozzle position may be adjusted to a position in a corresponding downward-propelling wind field to improve a spraying effect of the liquid.

In some embodiments, the total length of the front arm assembly 21 may be equal to the total length of the rear arm assembly 23. The front arm assembly 21 and the rear arm assembly 23 may be respectively located at two ends of the central frame 10, and extend outward in a V-shape. The total length of the front arm assembly 21 may be equal to the total length of the rear arm assembly 23, so that a weight balance position of the unmanned aerial vehicle may be adjusted, and that flying stability of the unmanned aerial vehicle may be improved.

In some embodiments, the first rotor assembly 221 may include a first motor and a first propeller that is mounted on an output shaft of the first motor. The first motor may drive the first propeller to rotate to generate a downward-propelling wind field. The first propeller may include two or more blades. In a rotation process of the first propeller, the blades may form a circular swept range, and the downward-propelling wind field may extend downward from the circular swept range. The structures of the second rotor assembly 211 and the third rotor assembly 231 may be the same as that of the first rotor assembly 221. The second rotor assembly 211 may include a second motor and a second propeller that is mounted on an output shaft of the second motor. The third rotor assembly 231 may include a third motor and a third propeller that is mounted on an output shaft of the third motor.

The first rotor assembly 221 may be located in a rotation plane different from those of the second rotor assembly 211 and the third rotor assembly 231, and a mounting position for the first rotor assembly 221 with respect to the second rotor assembly 211 and the third rotor assembly 231 may be adjusted to adjust the ranges of the downward-propelling wind fields of the unmanned aerial vehicle. In the output direction of the downward-propelling wind fields of the left arm set 20 and the right arm set 30, a swept range of the first propeller may at least partially overlap a swept range of the second propeller; and/or a swept range of the first propeller may at least partially overlap a swept range of the third propeller.

A first downward-propelling wind field may be generated in the swept range of the first propeller. A second downward-propelling wind field may be generated in the swept range of the second propeller. A third downward-propelling wind field may be generated in the swept range of the third propeller. Because the first propeller is located at a lower vertical position with respect to the second propeller and the third propeller, the second and third downward-propelling wind fields generated by the second propeller and the third propeller may at least partially overlap the first downward-propelling wind field, so that the downward pressure of the first downward-propelling wind field may become greater. The penetration of the liquid located in the first downward-propelling wind field may be improved, and a spraying effect may be better.

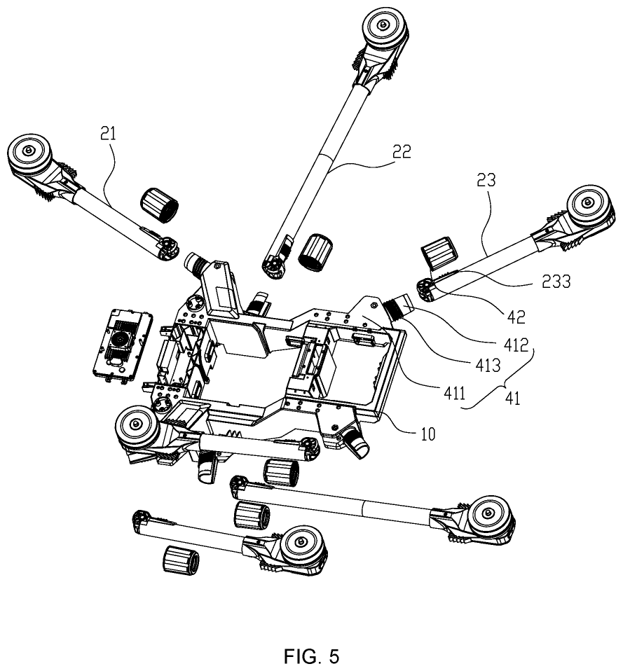

As shown in FIG. 4 and FIG. 5, the front arm assembly 21, the rear arm assembly 23, and the middle arm assembly 22 may be fixedly connected to the central frame 10 radially. When deployed, the unmanned aerial vehicle may have a large size such that the transportation thereof may be difficult. In some embodiments, the front arm assembly 21, the rear arm assembly 23, and the middle arm assembly 22 may all be rotatably and/or pivotably coupled to the central frame 10. The front arm assembly 21, the rear arm assembly 23, and the middle arm assembly 22 may be pivotable to unfolded positions where they are close to the central frame 10, or flying positions where they radially extend outward from the central frame 10.

The unmanned aerial vehicle may have a folding state and a deployed state. When the unmanned aerial vehicle is in an application scenario such as transport or storage, the left arm set 20 and the right arm set 30 may be in a folding state. When the unmanned aerial vehicle is in a flying or standby state, the left arm set 20 and the right arm set 30 may be in a deployed state. Correspondingly, the front arm assembly 21, the rear arm assembly 23, and the middle arm assembly 22 may be rotatably and/or pivotably coupled to the central frame 10. For example, the left arm set 20 may pivot counterclockwise around the central frame 10, and the right arm set 30 may pivot clockwise around the central frame 10 so that the left arm set 20 and the right arm set 30 may be folded to the central frame 10, or reversely, pivot to enter the deployed state.

The middle arm assembly 22 may be located in a plane different from the planes where the front arm assembly 21 and the rear arm assembly 23 are located, respectively. The rotation and/or pivoting directions of the front arm assembly 21, the rear arm assembly 23, and the middle arm assembly may be the same, or the rotation and/or pivoting direction of at least one of the front arm assembly 21, the rear arm assembly 23, and the middle arm assembly may be reversed. In some embodiments, the rotation and/or pivoting directions of the front arm assembly 21, the rear arm assembly 23, and the middle arm assembly may be the same. In some embodiments, the front arm assembly 21 and the middle arm assembly 22 may pivot toward the rear arm assembly 23, and the rear arm assembly 23 may pivot toward the middle arm assembly 22.

The middle arm assembly 22 may be located close to one side of the front arm assembly 21, and the total length of the middle arm assembly 22 may be greater than that of the front arm assembly 21. The middle arm assembly 22 may pivot toward the rear arm assembly 23 to be folded to the central frame 10. Correspondingly, the length of part of the middle arm assembly 22 protruding from the central frame 10 may be reduced, so that the overall size of the unmanned aerial vehicle may be reduced.

When the front arm assembly 21 and the rear arm assembly 23 are located on the same plane, the front arm assembly 21 may pivot toward the rear arm assembly 23, so that the front arm assembly 21 may fit into the central frame 10 at a position close to the rear arm assembly 23, or fit into the real arm assembly 23. Alternatively, the front arm assembly 21 may pivot toward the rear arm assembly 23, and the rear arm assembly 23 may pivot toward the front arm assembly 21, so that the front arm assembly 21 and the rear arm assembly 23 may fit into the central frame 10.

When the front arm assembly 21 and the rear arm assembly 23 are located in different planes, the front arm assembly 21 may pivot toward the rear arm assembly 23, so that the front arm assembly 21 may fit into the central frame 10 at a position close to the rear arm assembly 23, or fit into the real arm assembly 23. Alternatively, the front arm assembly 21 may pivot toward the rear arm assembly 23, and the rear arm assembly 23 may pivot toward the front arm assembly 21, so that the front arm assembly 21 and the rear arm assembly 23 may fit into the central frame 10.

The front arm assembly 21, the rear arm assembly 23, and the middle arm assembly 22 may be disposed such that they can be pivotably mounted on the central frame 10 and can be folded and deployed conveniently. The rotation plane of the middle arm assembly 22 may be different from the rotation planes of the front arm assembly 21 and the rear arm assembly 23. This can improve the ways to fold the unmanned aerial vehicle and enrich the ways to accommodate the unmanned aerial vehicle, so that the unmanned aerial vehicle can be transported conveniently.

Still referring to FIG. 4 and FIG. 5, the unmanned aerial vehicle may further include a locking apparatus 40 fixed on the central frame 10, where the front arm assembly 21, the rear arm assembly 23, and the middle arm assembly 22 may all be fixedly or rotatably and/or pivotably coupled to the central frame 10 by such locking apparatuses 40. The left arm set 20 and the right arm set 30 may be rotatably and/or pivotably coupled to the central frame 10. When the unmanned aerial vehicle is in the flying state, the left arm set 20 and the right arm set 30 may be in the deployed positions. The locking apparatuses 40 may be fixedly connected to the central frame 10. The locking apparatuses 40 may be configured to lock the front arm assembly 21, the rear arm assembly 23, and the middle arm assembly 22 at the deployed positions with respect to the central frame 10.

The locking apparatuses 40 may be disposed on the central frame 10 at regular intervals. For example, the unmanned aerial vehicle may be a six-rotor agricultural unmanned aerial vehicle. In this case, three locking apparatuses 40 may be fixedly connected to one side of the central frame 10. The front arm assembly 21, the rear arm assembly 23, and the middle arm assembly 22 may be assembled on the central frame 10, respectively, by using corresponding locking apparatuses 40. In addition, the front arm assembly 21, the rear arm assembly 23, and the middle arm assembly 22 may pivot with respect to the central frame 10 via the locking apparatuses 40.

Correspondingly, the locking apparatus 40 may have a locking state and an unlocking state. When the locking apparatuses 40 lock the front arm assembly 21, the rear arm assembly 23, and the middle arm assembly 22, the front arm assembly 21, the rear arm assembly 23, and the middle arm assembly 22 may be fixed with respect to the central frame 10, so that the front arm assembly 21, the rear arm assembly 23, and the middle arm assembly 22 may be in the deployed positions. When the locking apparatuses 40 unlock the front arm assembly 21, the rear arm assembly 23, and the middle arm assembly 22, the front arm assembly 21, the rear arm assembly 23, and the middle arm assembly 22 may pivot with respect to the central frame 10, so that the front arm assembly 21, the rear arm assembly 23, and the middle arm assembly 22 may be folded toward the central frame 10 and may be in the folded positions. The states of the left arm set 20 and the right arm set 30 may be adjusted conveniently, by using the locking apparatuses 40.

In some embodiments, the locking apparatus 40 may include a fixing base 41 and a locking member 42. The fixing base 41 may be fixedly connected to the central frame 10. The front arm assembly 21, the rear arm assembly 23, and the middle arm assembly 22 may be rotatably and/or pivotably coupled to the corresponding fixing bases 41, respectively. Each of the front arm assembly 21, the rear arm assembly 23, and the middle arm assembly 22 may be sleeved over by a locking member 42, where the locking member 42 may be locked to the fixing base 41 and limits the pivoting of the front arm assembly 21, the rear arm assembly 23, or the middle arm assembly 22 around the corresponding fixing base 41.

The middle arm assembly 22 may be used as an example for description. One end of the first connecting rod set 222 may be rotatably and/or pivotably coupled to the fixing base 41, so that the middle arm assembly 22 may be rotatably and/or pivotably coupled to the fixing base 41. The locking member 42 may externally sleeve over the first connecting rod set 222, and move with the pivoting of the first connecting rod set 222. In some embodiments, when the first connecting rod set 222 pivots to a deployed position, the first connecting rod set 222 abuts the fixing base 41 at the preset deployed position. The locking member 42 may move along an axial direction of the first connecting rod set 222, and may be connected (e.g., thread-connected) to the fixing base 41. The locking member 42 may be connected to the fixing base 41. In this case, the first connecting rod set 222 may be limited on the fixing base 41 by the locking member 42, so that the middle arm assembly 22 may be in a deployed position. A reverse operation may cause the middle arm assembly 22 to enter a pivotable state where the middle arm assembly 22 may perform deploying and folding actions freely. The manners of connecting the front arm assembly 21 and the rear arm assembly 23 to the central frame 10 may be the same as or similar to the manner of connecting the middle arm assembly 22 to the central frame 10.

In some embodiments, the fixing base 41 may include a fixing portion 411 fixedly connected to the central frame 10 and a connecting portion 412 protruding from the fixing portion 411. The fixing portion 411 and the connecting portion 412 may form a T-shaped structure. In some embodiments, the connecting portion 412 may be obliquely disposed with respect to the fixing base 41. The front arm assembly 21, the rear arm assembly 23, or the middle arm assembly 22 may be rotatably and/or pivotably coupled to the connecting portion 412. The locking member 42 may be fixed to the connecting portion 412, and externally sleeve over the front arm assembly 21, the rear arm assembly 23, or the middle arm assembly 22.

The middle arm assembly 22 is still used as an example for description. A through hole may be provided on the first connecting rod set 222. A connecting shaft may pass through the through hole and may be rotatably and/or pivotably coupled to the connecting portion 412. An opening 414 may be provided on the connecting portion 412. The first connecting rod set 222 may be inserted in the opening 414 and rotatably and/or pivotably coupled to the connecting shaft. A first external partial-thread 413 may be provided on an outer surface of the connecting portion 412. The locking member 42 may have a pipe-shaped structure, and an internal thread is provided on its inner surface. The locking member 42 may sleeve over the first connecting rod set 222, and may be thread-connected to the connecting portion 412. A wall surface of the locking member 42 may be used to limit rotation and motion of the first connecting rod set 222.

In some embodiments, a threaded portion 233 may be provided on an outer surface of the first connecting rod set 222, and the threaded portion 233 may fit a notch of the opening 414. When the locking member 42 is thread-connected to the first connecting rod set 222, its internal thread may be connected to a second external partial-thread of the threaded portion 233, so that the first connecting rod set 222 may be thread-connected to the locking member 42. Therefore, the first connecting rod set 222 is limited to further pivoting, and the connection may be firm.

In some embodiments, the frame may further include a linkage assembly assembled on the central frame 10, where the linkage assembly may be configured to drive the front arm assembly 21, the rear arm assembly 23, and the middle arm assembly 22 to pivot or rotate synchronously or sequentially. The linkage assembly may be mounted on the central frame 10. The linkage assembly may be actuated manually, for example, by an operator by pushing a wrench, so that a link mechanism may enable the front arm assembly 21, the rear arm assembly 23, and the middle arm assembly 22 to pivot or rotate synchronously or sequentially. The linkage assembly may be automatically actuated. For example, a motor may drive the link mechanism to enable the front arm assembly 21, the rear arm assembly 23, and the middle arm assembly 22 to pivot or rotate synchronously or sequentially. The linkage assembly may fold or deploy the left arm set 20 and the right arm set 30, and improve folding and deploying efficiency of the unmanned aerial vehicle.

The methods and/or apparatuses provided by the embodiments of the present disclosure are described in detail above. The principles and implementations of the present disclosure are described herein by using specific examples. The description of the embodiments is merely provided to help understand the method and core idea of the present disclosure. In addition, a person of ordinary skill in the art can make variations and modifications to the present disclosure in terms of the specific implementations and application scopes according to the idea of the present disclosure. Therefore, if there is no conflict, the foregoing embodiments and features in the embodiments may be mutually combined. Therefore, the content of this specification shall not be construed as a limitation on the present disclosure.

What is claimed is:

1. An unmanned aerial vehicle, comprising:
a frame comprising a central frame, and a first arm set and a second arm set mounted on the central frame, each of the first arm set and the second arm set including a first arm assembly, a second arm assembly, and a third arm assembly assembled on the central frame, the first arm assembly being located between the second arm assembly and the third arm assembly; and
a control module mounted on the frame and configured to control the first arm set and the second arm set,
wherein:
the first arm assembly includes a first rotor assembly,
the second arm assembly includes a second rotor assembly,
the third arm assembly includes a third rotor assembly,
in an output direction of downward-propelling wind fields generated by the first arm set and the second arm set, one of a rotation plane of the first rotor assembly, a rotation plane of the second rotor assembly, and a rotation plane of the third rotor assembly is located at a different position from the other.

2. The unmanned aerial vehicle according to claim 1, wherein
the first rotor assembly is located at an end of the first arm assembly,
the second rotor assembly is located at an end of the second arm assembly,
the third rotor assembly is located at an end of the third arm assembly,
a vertical position of the end of the first arm assembly is lower than a vertical position of the end of the second arm assembly, and
the vertical position of the end of the first arm assembly is lower than a vertical position of the end of the third arm assembly.

3. The unmanned aerial vehicle according to claim 1, wherein
the first arm assembly includes a first connecting rod set to connect the first rotor assembly to the central frame,
the second arm assembly includes a second connecting rod set to connect the second rotor assembly to the central frame,
the third arm assembly includes a third connecting rod set to connect the third rotor assembly to the central frame,
a vertical position of the first connecting rod set is lower than a vertical position of the second connecting rod set, and
the vertical position of the first connecting rod set is lower than a vertical position of the third connecting rod set.

4. The unmanned aerial vehicle according to claim 3, wherein a distance between a first position where the first connecting rod set is connected to the central frame and a third position where the third connecting rod set is connected to the central frame is greater than a distance between the first position and a second position where the second connecting rod set is connected to the central frame.

5. The unmanned aerial vehicle according to claim 3, wherein a total length of the first arm assembly is greater than a total length of the second arm assembly, and the total length of the first arm assembly is greater than a total length of the third arm assembly.

6. The unmanned aerial vehicle according to claim 5, wherein the total length of the second arm assembly is equal to the total length of the third arm assembly.

7. The unmanned aerial vehicle according to claim 1, wherein
the first rotor assembly includes a first propeller,
the second rotor assembly includes a second propeller,
the third rotor assembly includes a third propeller, and
in the output direction of the downward-propelling wind fields generated by the first arm set and the second arm set, a swept range of the first propeller at least partially overlaps at least one of a swept range of the second propeller or a swept range of the third propeller.

8. The unmanned aerial vehicle according to claim 1, wherein
the first arm assembly, the second arm assembly, and the third arm assembly are all rotatably coupled to the central frame, and
each of the first arm assembly, the second arm assembly, and the third arm assembly is configured to rotate to a folded position adjacent to the central frame, or is configured to radially extend outward from the central frame to be at a deployed position.

9. The unmanned aerial vehicle according to claim 8, wherein rotation directions of the first arm assembly, the second arm assembly, and the third arm assembly from the folded position to the deployed position are the same.

10. The unmanned aerial vehicle according to claim 8, wherein when moving from the respective deployed position to the folded position, the first arm assembly and the second arm assembly rotate toward the third arm assembly, respectively, and the third arm assembly rotates toward the first arm assembly.

11. The unmanned aerial vehicle according to claim 1, further comprising a plurality of locking apparatuses fixed on the central frame,
wherein the first arm assembly, the second arm assembly, and the third arm assembly are all fixedly or rotatably coupled to the central frame by the corresponding locking apparatus.

12. The unmanned aerial vehicle according to claim 11, wherein
the locking apparatus includes a fixing base and a locking member, the fixing base being fixedly connected to the central frame,
each of the first arm assembly, the second arm assembly, and the third arm assembly is rotatably coupled to the corresponding fixing base, and
the locking member is configured to prevent the first arm assembly, the second arm assembly, or the third arm assembly from rotating around the corresponding fixing base.

13. The unmanned aerial vehicle according to claim 12, wherein each of the first arm assembly, the second arm assembly, and the third arm assembly is sleeved over by the corresponding locking member.

14. The unmanned aerial vehicle according to claim 12, wherein
the fixing base includes a fixing portion fixedly connected to the central frame and a connecting portion protruding from the fixing portion, and
at least one of the first arm assembly, the second arm assembly, or the third arm assembly is rotatably coupled to the connecting portion.

15. The unmanned aerial vehicle according to claim 14, wherein the locking member is fixed to the connecting portion and externally sleeves over the first arm assembly, the second arm assembly, or the third arm assembly.

16. The unmanned aerial vehicle according to claim 14, wherein an external surface of the connecting portion is provided with a first external partial-thread,
at least one of the first arm assembly, the second arm assembly, or the third arm assembly comprises a threaded portion having a corresponding second external partial-thread to complement the first external partial-thread.

17. The unmanned aerial vehicle according to claim 16, wherein the connecting portion is provided with an opening to accommodate the at least one of the first arm assembly, the second arm assembly, or the third arm assembly.

18. The unmanned aerial vehicle according to claim 16, wherein the locking member is provided with an internal thread to fit with the first external partial-thread and the second external partial-thread,
the locking member is movable between a locking position and an unlocking position along an axial direction of the at least one of the first arm assembly, the second arm assembly, or the third arm assembly,
in the locking position, the locking member is coupled to the connecting portion via the internal threads fitting with the first external partial-thread and the second external partial-thread, to lock the at least one of the first arm assembly, the second arm assembly, or the third arm assembly, and
in the unlocking position, the locking member is detached from the connecting portion, to unlock the at least one of the first arm assembly, the second arm assembly, or the third arm assembly.

19. The unmanned aerial vehicle according to claim 1, further comprising a linkage assembly assembled on the central frame, wherein the linkage assembly is configured to drive the second arm assembly, the third arm assembly, and the first arm assembly to pivot synchronously or sequentially.

20. An unmanned aerial vehicle, comprising:
a central frame;
a first arm assembly rotatably coupled to the central frame and including a first rotor assembly;
a second arm assembly rotatably coupled to the central frame and including a second rotor assembly;
a third arm assembly rotatably coupled to the central frame, the first arm assembly being located between the second arm assembly and the third arm assembly; and
a control module mounted on the central frame and configured to control the first rotor assembly, the second rotor assembly and the third arm assembly,
wherein:
each of the first arm assembly, the second arm assembly, and the third arm assembly is configured to rotate to a folded position adjacent to the central frame, and radially extend outward from the central frame to be at a deployed position; and
when all of the first arm assembly, the second arm assembly, and the third arm assembly being at the deployed position, a rotation plane of the first rotor assembly is located at a different height from a rotation plane of the second rotor assembly or the third rotor assembly.
